(19) United States
(12) Patent Application Publication
(10) Pub. No.: US 2006/0192770 A1
(43) Pub. Date: Aug. 31, 2006

(54) Information processing apparatus and method for electrostatic capacity type switch

(75) Inventor: Hajime Suzukawa, Hino-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/364,151

(22) Filed: Feb. 27, 2006

(30) Foreign Application Priority Data
Feb. 28, 2005 (JP) 2005-053331

(51) Int. Cl. G09G 5/00

(52) U.S. Cl. 345/173

(57) ABSTRACT

According to one embodiment, an information processing apparatus comprises a touch switch which inputs data in the main body according to a change in electrostatic capacity, and touch switch is arranged at the upper face of the main body, a display unit is supported on the main body, and the display unit is rotated between a closed position at which the upper face of the main body is covered and an open position at which the upper face of the main body is exposed, a detector is used to detect whether or not an angle formed between the front face of the display unit and the upper face of the main body is less than a predetermined value, and a controller which prohibits data input operation by the touch switch when it is detected that the angle is less than the predetermined value.

### CROSS-REFERENCE TO RELATED APPLICATIONS

This application is based upon and claims the benefit of priority from Japanese Patent Application No. 2005-053331, filed Feb. 28, 2005, the entire contents of which are incorporated herein by reference.

### BACKGROUND

1. Field

Embodiments of the invention relate to an information processing apparatus comprising an electrostatic capacity type switch, and a method of controlling the same.

2. Description of the Related Art

Presently, there exists an information processing apparatus in which, for example, a resistance film type touch panel is provided. A cover is generally provided to the information processing apparatus in order to protect the surface of the touch panel. If the cover is closed when the apparatus is operating, the cover contacts the touch panel, which may cause erroneous operation.

In Jpn. Pat. Appln. KOKAI Publication No. 2002-7070 (FIGS. 3 and 9), there is described a technique for preventing erroneous operation due to the contact between the cover and the touch panel. This reference describes that an optical sensor (cover open/close recognizing unit) detects closing of the cover to suspend an input operation from the touch panel. Since the resistance film type touch panel is operated through physical contact, the closing of the cover is detected, thereby restricting erroneous operation due to the contact between the cover and the touch panel.

There is an electrostatic capacity type switch as input means for the information processing apparatus. The electrostatic capacity type touch switch may cause erroneous output due to a change in the electrostatic capacity caused by an object on the touch switch and noise as well as contact on the switch by a person. Thus, it is difficult to restrict erroneous output with a configuration for suspending the input operation by closing the cover.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an exemplary schematic configuration of a personal computer according to a first embodiment of the present invention;

FIG. 2 is an exemplary plan view showing details of AV buttons according to the first embodiment;

FIG. 3 is an exemplary block diagram showing a circuit configuration according to the first embodiment;

FIG. 4 is an exemplary flowchart showing erroneous output control according to the first embodiment;

FIG. 5A, FIG. 5B, FIG. 5C, and FIG. 5D are exemplary diagrams showing an operation of closing a display unit;

FIG. 6A, FIG. 6B, FIG. 6C, and FIG. 6D are exemplary diagrams showing an operation of opening the display unit;

FIG. 7 is an exemplary block diagram showing a circuit configuration according to a second embodiment; and

FIG. 8 is an exemplary flowchart showing erroneous output control according to the second embodiment.

### DETAILED DESCRIPTION

Various embodiments according to the invention will be described hereinafter with reference to the accompanying drawings. In general, according to one embodiment of the invention, an information processing apparatus and a method for restricting erroneous output from an electrostatic capacity type switch or erroneous operation due to the erroneous output.

### First Embodiment

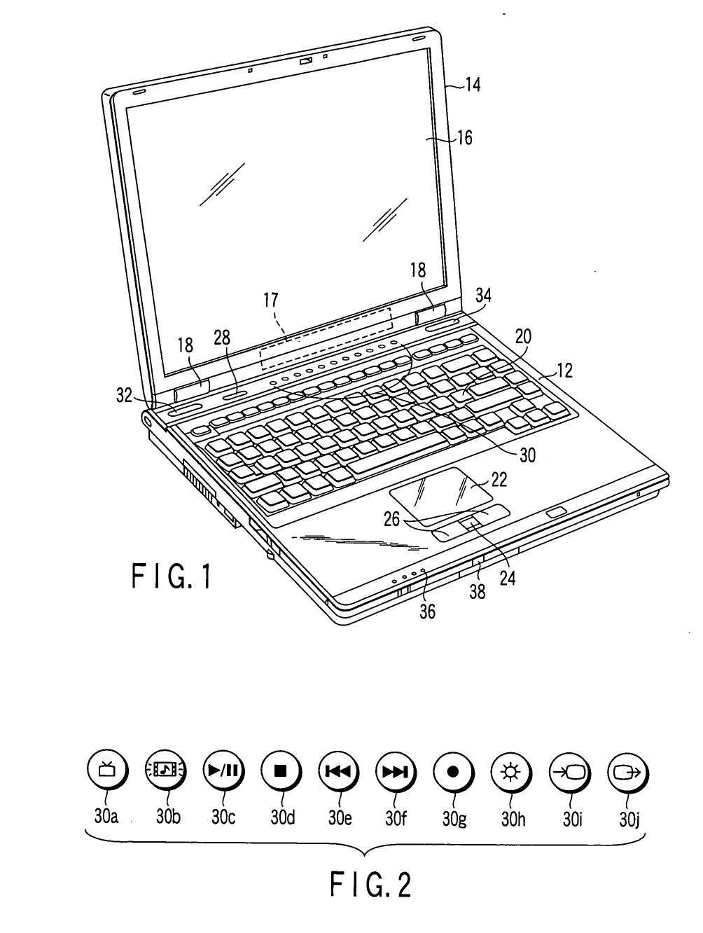

FIG. 1 is a diagram showing a configuration of a notebook type personal computer as an information processing apparatus according to a first embodiment of the present invention.

The personal computer comprises a computer main body 12 and a display unit 14. The display unit 14 incorporates therein a LCD (Liquid Crystal Display) 16 as a display panel, a backlight (not shown) as a light emitting unit, and an inverter 17 for driving the backlight. The display unit 14 is mounted on a hinge (supporting unit) 18 provided at the back end of the computer main body 12 to rotatably change between a closed position at which the upper face of the computer main body 12 is covered and an open position at which the upper face of the computer main body 12 is exposed.

In recent years, an antenna required for a wireless LAN or the like is incorporated in the display unit 14. Though a diversity type antenna utilize a pair of antennas, since a certain distance should exist between the antennas, the antennas are provided at the right and left sides of the LCD 16, respectively. Therefore, the inverter 17 is provided below the LCD 16, that is, at a space between the base end position of the display unit 14 supported by the hinge 18 and the LCD 16.

According to one embodiment, the computer main body 12 has a thin box-shape housing, and is provided with a keyboard 20 at the center of the upper face of the housing. A palm rest is formed on the upper face of the housing of the computer main body 12. There are provided a touch pad 22, a scroll button 24, and a touch pad control button 26 substantially at the center of the palm rest. There are arranged a power button 28 for turning ON/OFF a power supply of the computer main body 12, ten AV switches 30, and left and right speakers 32 and 34 at the upper face of the housing at the back of the computer main body 12. There are provided various indicators (LED) 36 indicating a power supply state or an operation state of an HDD and a remote control receiving unit 38 at the front face of the housing.

The AV switch 30 is a touch switch for inputting data into the computer main body 12 (i.e., to components within the main body) in response to detection of a change in the electrostatic capacity. The AV switch 30 has a capacitor. If, for example, a finger contacts the surface of the AV switch 30, the electrostatic capacity of the capacitor changes and a switch controller detects the change. The switch controller transmits a signal to an embedded controller/keyboard controller IC 112 indicating that the AV switch 30 has changed in the electrostatic capacity. Then, a predetermined operation is performed by the personal computer according to the input data.

FIG. 2 is an exemplary diagram showing details of the ten AV switches 30. There are provided, from left, a TV switch 30a, a CD/DVD switch 30b, a play (playback)/pause (interruption) switch 30c, a stop switch 30d, a next switch 30e, a preview switch 30f, a record switch 30g, a luminance switch 30h, a monitor input switch 30i, and a TV output switch 30j.

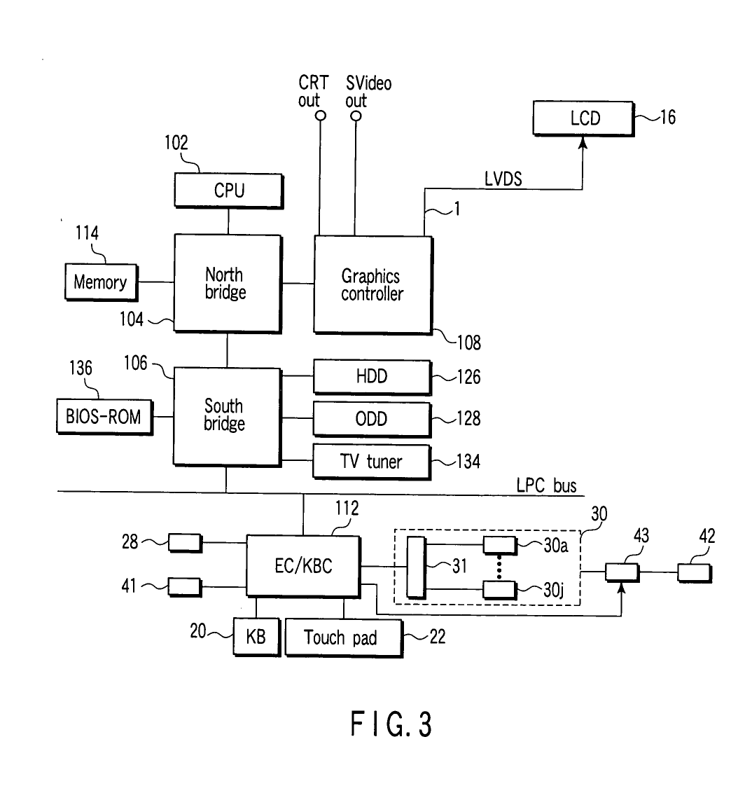

Each of these switches 30a to 30j is the electrostatic capacity type touch switch as described above. The switch controller 31 of FIG. 3 transmits to the embedded controller/keyboard controller IC 112 which of the switches 30a to 30j has changed in the electrostatic capacity.

The TV switch 30a is a touch switch for performing a TV watching application for watching TV. If a user touches the surface of the TV switch 30a, for example, with a finger, a TV watching application is performed or terminated. The CD/DVD switch 30b is a touch switch for performing the AV (audio visual) application in order to listen to or watch a CD or DVD. When the user touches the surface of the CD/DVD switch 30b with a finger, the AV (audio visual) application is performed. When the play (playback)/pause (interruption) switch 30c is pressed, the AV (audio visual) application starts or interrupts playback. The stop switch 30d has a function of suspending playback.

When the user touches the surface of the next switch 30e with a finger, he/she can advance to a next track, chapter, or data. When the preview switch 30f is pressed, the user can return to a previous track, chapter, or data. When the user touches the surface of the record switch 30g with a finger, a TV program is recorded on a DVD medium or the like mounted on a hard disk drive or optical disk drive provided in the computer main body 12.

When the user touches the surface of the luminance switch 30h with a finger, a screen for adjusting the luminance of the LCD panel 16 is displayed on the LCD 16. When the user touches the surface of the monitor input switch 30i with a finger during the operation of the AV audio visual application, a video source to be displayed on the LCD 16 is changed from a video to be played back by the AV audio visual application to a video to be externally input. When the user touches the surface of the TV output switch 30j with a finger during the operation of the operation system, the display of the LCD panel 16 is switched to the TV output.

When the display unit 14 of FIG. 1 is placed in the closed position, the AV switches 30 are opposed or substantially opposed to the inverter 17. Depending on the type of computer, when the display unit 14 is in the closed position, the AV switches 30 may be opposed or substantially opposed to the display panel 16. Further, the AV switches 30 may be opposed or substantially opposed to the inverter 17 and the display panel 16.

The personal computer continues the operation even when the display unit 14 is closed, and it can perform a processing such as audio playback.

Next, a system configuration of the computer is described with reference to FIG. 3.

As shown in FIG. 3, the computer includes a CPU 102, a north bridge 104, a main memory 114, a graphics controller 108, a south bridge 106, a BIOS-ROM 136, a hard disk drive (HDD) 126, an optical disk drive (ODD) 128, a TV tuner 134, an embedded controller/keyboard controller IC (EC/KBC) 112, a rotation angle sensor 41, a power supply 42, a power supply switch 43, and the like.

The CPU 102 is a processor provided for controlling the operation of the computer, and executes the operating system (OS) and various application programs which are loaded from the hard disk drive (HDD) 126 to the main memory 114.

The CPU 102 also executes a system BIOS (Basic Input Output System) stored in the BIOS-ROM 136. The system BIOS is a program for hardware control.

The north bridge 104 is a bridge device for connecting a local bus of the CPU 102 to the south bridge 106. The north bridge 104 incorporates therein a memory controller for access-controlling the main memory 114. Further, the north bridge 104 has a function of making communication with the graphics controller 108 via an AGP (Accelerated Graphics Port) bus or the like.

The graphics controller 108 is a display controller for controlling the LCD 16 used as a display monitor of the computer. This graphics controller 108 has a video memory (VRAM), and generates a video signal for forming a display image to be displayed on the LCD 16 from display data drawn on the video memory by the OS/application program.

The video signal generated by the graphics controller 108 is output to a line 1. Further, the graphics controller 108 has an interface for outputting an analog video signal to an external CRT (Cathode Ray Tube) and an interface for outputting an analog video signal to the outside via an S video terminal.

When the switch controller 31 detects a change in the electrostatic capacity of the capacitor provided in the switches 30a to 30j, the switch controller 31 transmits to the embedded controller/keyboard controller IC (EC/KBC) by a 16-bit serial signal from which switch an event signal has been output. A bit corresponding to the switch which has output the event signal becomes “Hi” so that the 16-bit serial signal can determine which switch has output the event signal.

The power supply 42 supplies power necessary for the operation of the computer. The power necessary for the operation of the AV switches 30 is supplied from the power supply 42 via the power supply switch 43. The rotation angle sensor 41 detects an angle formed between the front face of the display unit 14 and the upper face of the computer main body 12, and detects whether the angle formed between the front face of the display unit 14 and the upper face of the computer 12 is less than a predetermined angle (θ). The rotation angle sensor 41 may be provided on the computer main body 12 or may be provided in the display unit 14. When a detected angle is less than the predetermined angle “θ” (e.g., 30°), the rotation angle sensor 41 outputs a “closed” signal to the embedded controller/keyboard controller IC (EC/KBC) 112. The embedded controller/Keyboard controller IC (EC/KBC) 112 outputs an enable signal or disable signal to the power supply switch 43 according to an “open” signal/“closed” signal from the rotation angle sensor 41. For example, the embedded controller/keyboard controller IC (EC/KBC) 112 outputs the enable signal for the “open” signal, and outputs the disable signal for the “closed” signal.

When the enable signal is input, the power supply switch 43 performs power supply to the AV switches 30. When the disable signal is input, the power supply switch 43 interrupts power supply to the AV switches 30. That is, the power supply to the AV switches 30 is controlled according to the rotation angle.

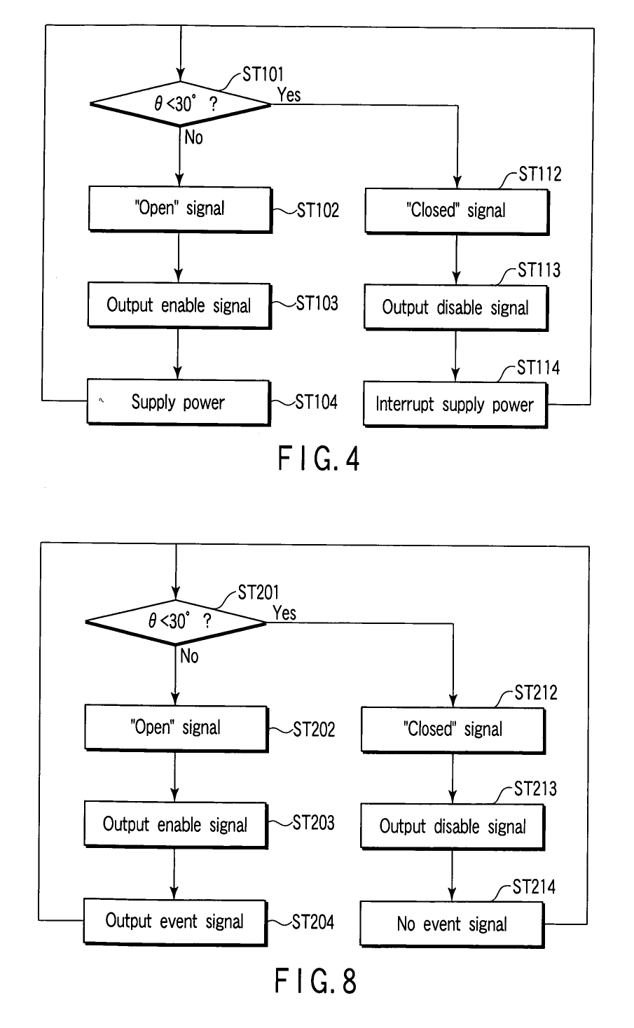

Next, an open/close operation of the display unit will be described with reference to a flowchart of FIG. 4. The following processing is performed when the main body is operating, which is a state where a predetermined operation can be performed by the AV switch.

At first, the rotation angle sensor 41 determines whether an angle formed between the front face of the display unit 14 and the upper face of the computer main body 12 (hereinafter, referred to as “rotation angle”) is less than the predetermined angle (e.g., 30°) (block ST101). When the rotation angle is not less than the predetermined angle, the rotation angle sensor 41 outputs the “open” signal to the embedded controller/keyboard controller IC 112 (block ST102). When the “closed” signal is input, the embedded controller/keyboard controller IC (EC/KBC) 112 outputs the enable signal to the power supply switch 43 (block ST103). The power supply switch 43 performs power supply to the AV switches 30 in the state where the enable signal is input (block ST104).

When the rotation angle is less than the predetermined angle (e.g., 30°) in block ST101, the rotation angle sensor 41 outputs the “closed” signal to the embedded controller/keyboard controller IC 112 (block ST 112). When the “closed” signal is input, the embedded controller/keyboard controller IC 112 outputs the disable signal to the power supply switch 43 (block ST113). The power supply switch 43 interrupts power to be supplied to the AV switches 30 in the state where the disable signal is input (block ST114).

It is contemplated that the predetermined angle (θ) may be any selected angle of rotation between the front face of the display unit 14 and the upper face of computer main body 12. For example, the predetermined angle may be less than or equal to 30° (θ≦30°). Of course, other angles of rotation may be used.

Next, there will be described a processing of preventing erroneous output of the AV switches 30 when opening/closing the display unit 14 with reference to the flowchart of FIG. 4 and FIGS. 5A-5D and FIGS. 6A-6D in consideration of the actual operation.

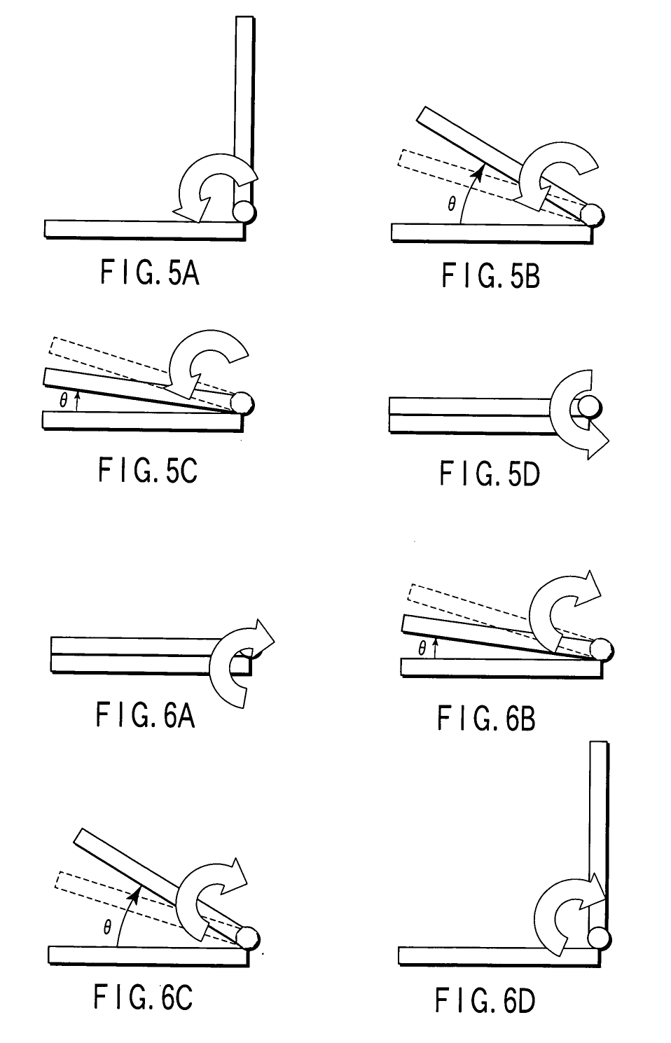

At first, there will be described an operation when the display unit 14 is rotated from the open position (FIG. 5A) to the closed position (FIG. 5D) with reference to FIGS. 5A-5D. In FIGS. 5B and 5C, the display unit 14 indicated by a dashed line is in the state where the rotation angle is 30°, namely the predetermined angle from this example.

The rotation angle is 30° or more at the initial stage of rotation shown in FIG. 5B. Since the rotation angle is 30° or more, the rotation angle sensor 41 outputs the “open” signal to the embedded controller/keyboard controller IC 112 (block ST102).

While the “open” signal is input, the embedded controller/keyboard controller IC (EC/KBC) 112 outputs the enable signal to the power supply switch 43 (block ST103). The power supply switch 43 performs power supply to the AV switches 30 in the state where the enable signal is input (block ST104).

There will be described a case where an operation of closing the display unit is advanced and the rotation angle of the display unit 14 becomes less than 30° as shown in FIG. 5C so that the rotation angle less than 30° is detected in block ST101. When it is determined in block ST101 that the rotation angle is less than 30°, the rotation angle sensor 41 outputs the “closed” signal to the embedded controller/keyboard controller IC 112 (block ST112). The “closed” signal is input so that the embedded controller/keyboard controller IC (EC/KBC) 112 outputs the disable signal to the power supply switch 43 (block ST113). Since the signal to be input into the power supply switch 43 is switched from the enable signal to the disable signal, the power supply switch 43 interrupts power to be supplied to the AV switches 30 (block ST114).

Next, there will be described an operation when the display unit 14 is rotated from the closed position (FIG. 6A) to the open position (FIG. 6D). In FIGS. 6B and 6C, the display unit 14 indicated by a dashed line is in the state where the rotation angel is 30°.

In the state shown in FIG. 6B, the rotation angle sensor 41 detects that the angle is less than 30°, and outputs the “closed” signal to the embedded controller/keyboard controller IC 112 (block ST112). While the “closed” signal is input, the embedded controller/keyboard controller IC (EC/KBC) 112 outputs the disable signal to the power supply switch 43 (block ST113). The power supply switch 43 interrupts power supply to the AV switches 30 in the state where the disable signal is input (block ST114).

As shown in FIG. 6C, there will be described a case where an operation of opening the display unit 14 is advanced and the rotation angle 30° or more is detected in block ST101. When it is determined in block ST101 that the rotation angle is not less than the predetermined angle (e.g., 30°), the rotation angle sensor 41 outputs the “open” signal to the embedded controller/keyboard controller IC 112 (block ST102). The “open” signal is input so that the embedded controller/keyboard controller IC (EC/KBC) 112 outputs the enable signal to the power supply switch (block ST103). Since the signal to be input into the power supply switch 43 is switched from the disable signal to the enable signal, the power supply switch 43 supplies power to the AV switches 30 (block ST104).

When the angle formed between the upper face of the personal computer main body 12 and the upper face of the display unit 14 becomes less than the predetermined angle (e.g., 30°), the inverter 17/LCD 16 as a generating source of noise becomes near to the AV switches 30 so that the noise becomes stronger and an erroneous operation of the AV switches 30 may easily occur. Thus, in the present embodiment, when the rotation angle becomes less than 30°, the power supply to the AV switches 30 is interrupted to suspend the operation of the switches 30. Since the operation of the switches 30 is suspended, the AV switches 30 will not cause erroneous operation due to the vicinity of the inverter 17 or the display unit 14.

In the present embodiment, the power supply to the AV switches 30 is interrupted when the rotation angle is less than the predetermined angle (e.g., 30°). However, the rotation angle at which the power supply is interrupted is not limited to less than 30°, and may be set according to the distance between the inverter 17 or the LCD 16 and the electromagnetic wave source, and between the inverter 17 or the LCD 16 and the AV switch 30.

The present embodiment is constituted so that the embedded controller/keyboard controller IC 112 controls the power supply switch 43, but the power supply switch 43 may control the power supply to the AV switches 30 according to the output signal from the rotation angle sensor 41.

### Second Embodiment

There will be described a configuration capable of restricting erroneous operation due to erroneous detection by the AV switch 30.

An appearance configuration of the personal computer is the same as the appearance configuration shown in FIG. 1, and illustration and description thereof will not be described.

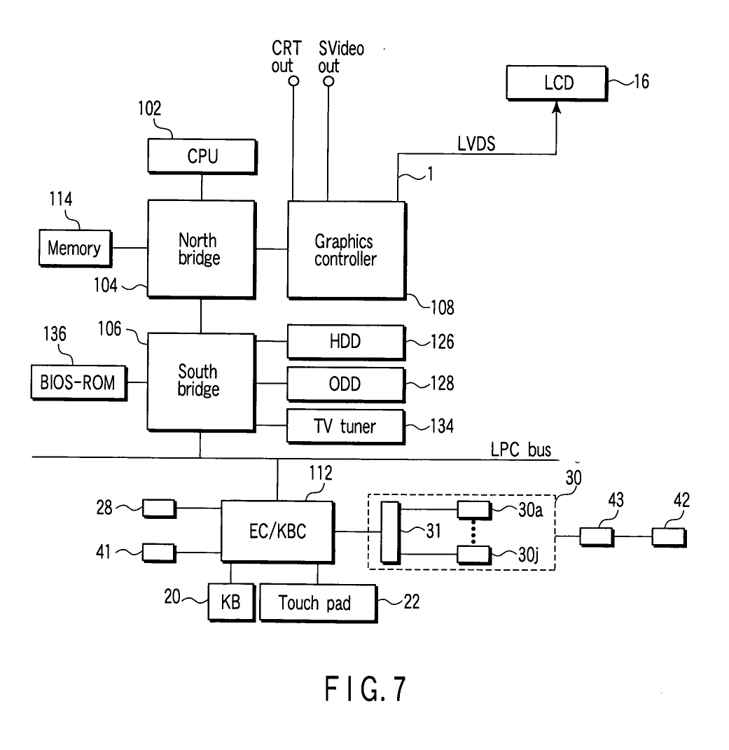

A system configuration of the computer will be described with reference to FIG. 7. Description of similar parts identical to those in the system configuration shown in FIG. 3 will not be described.

In the present apparatus, the embedded controller/keyboard controller IC (EC/KBC) 112 outputs the enable signal/disable signal to the controller 31 in the AV switches 30. The controller 31 controls output of the event signal according to the enable signal/disable signal.

There will be described a control processing for preventing erroneous operation in opening/closing operation with reference to a flowchart of FIG. 8.

At first, the rotation angle sensor 41 determines whether the angle formed between the front face of the display unit 14 and the upper face of the computer main body 12 (hereinafter, referred to as “rotation angle”) is less than a predetermined angle (e.g., 30°) (block ST201). When the rotation angle is not less than the predetermined angle, the rotation angle sensor 41 outputs the “open” signal to the embedded controller/keyboard controller IC 112 (block ST202). When the “closed” signal is input, the embedded controller/keyboard controller IC 112 outputs the enable signal to the switch controller 31 (block ST203). The switch controller switch 31 outputs a serial signal corresponding to the event signal from the AV switch 30 to the embedded controller/keyboard controller IC 112 in the state where the enable signal is input (block ST204).

When it is determined in block ST201 that the detected angle is less than 30°, the rotation angle sensor 41 outputs the “closed” signal to the embedded controller/keyboard controller IC 112 (block ST 212). When the “closed” signal is input, the embedded controller/keyboard controller IC (EC/KBC) 112 outputs the disable signal to the switch controller 31 (block ST213). The switch controller 31 prohibits the event signal from being transmitted from the AV switch 30 to the embedded controller/keyboard controller IC 112, and outputs the serial signal, by which all the switches 30a to 30j do not output the event signal, to the embedded controller/keyboard controller IC 112 in the state where the disable signal is input (block ST204).

As described above, the serial signal corresponding to the event signal output from the AV switch 30 according to the rotation angle is controlled. When the detected angle is less than the predetermined angle (e.g., 30°), the switch controller 31 controls such that the serial signal corresponding to the event signal is not output to the embedded controller/keyboard controller IC (EC/KBC) 112, thereby preventing erroneous operation even when the AV switch 30 erroneously outputs due to the proximity of the generating source of noise of the inverter 17, the display unit 14 or the like.

The present embodiment is constituted so that the serial signal corresponding to the event signal is not output when the rotation angle is less than the predetermine angle (e.g., 30°). However, the control angle is not limited to less than 30°, and may be set according to the distance between the inverter 17 or the LCD 16 and the electromagnetic wave source and between the inverter 17 or the LCD 16 and the AV switch 30.

The present embodiment is constituted so that the embedded controller/keyboard controller IC 112 controls the switch controller 31, but the switch controller 31 may control the output of the event signal according to the output signal of the rotation angle sensor 41.

As described above, when the rotation angle is less than the predetermined angle (e.g., 30°), if the serial signal, by which any event signal is active, is input into the embedded controller/keyboard controller IC 112, the embedded controller/keyboard controller IC 112 may perform a processing of disabling the active event signal.

### Third Embodiment

The configuration described in the first and second embodiments can prevent erroneous operation when the rotation angle is less than the predetermined angle. However, even when the rotation angle is 30° or more, an erroneous operation may occur due to an electromagnetic noise or the like from a peripheral electronic device, for example. Even when the rotation angle is the predetermined value or more, the following processing can avoid the erroneous operation.

That is, when the event signal is output from two or more switches among the switches 30a to 30j, the event signal is disabled. When the AV switch 30 erroneously operates due to noise or the like, the noise may influence several switches. Therefore, it is generally rare that only one switch erroneously operates. Thus, when the event signal is output from several switches, it is usually caused by erroneous operation.

As described in the first embodiment, the embedded controller/keyboard controller IC 112 determines from which switch the event signal has been output by the 16-bit serial signal. When the embedded controller/keyboard controller IC 112 detects several “Hi” signals in the 16-bit serial signal, the embedded controller/keyboard controller IC 112 can detect that the event signal has been output from the several switches. The embedded controller/keyboard controller IC 112 detects that the event signal has been output from several switches, and then processes the event signals as disable.

This processing is combined with the configuration shown in the first or second embodiment, thereby preventing problems from occurring due to the erroneous operation of switches caused by noise or the like, irrespective of the rotation angle.

The configuration described in the present embodiment can disable the switching operation also when several switches are pressed due to human error.

As described above, in each embodiment, when the angle formed between the front face of the display unit 14 and the upper face of the computer main body 12 is detected to be less than the predetermined value, the input operation of the touch switch is automatically prohibited, thereby preventing occurrence of erroneous operation caused by proximity of the touch switch and the LCD 16 or the inverter 17. Thus, even when the touch switch is arranged at the back of the upper face and the back of the computer main body 12 where the user can easily operate, it is possible to prevent the touch switch from erroneously operating due to noise from the display unit 14.

The present invention is not limited to the embodiments, and can be embodied by modifying constituents without departing from the spirit in practice. Further, several constituents disclosed in the embodiments can be appropriately combined to form various inventions. For example, some constituents may be deleted from all the constituents shown in the embodiments. Furthermore, constituents throughout different embodiments may be combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a main body including an upper face;
a first touch switch positioned on the upper face of the main body, the first touch switch to input data according to a change in electrostatic capacity;
a display unit coupled to the main body and including a front face, the display unit being rotational between a closed position at which the upper face of the main body is covered and an open position at which the front face of the display unit is exposed;
a sensor configure to detect whether or not an angle formed between the front face of the display unit and the upper face of the main body is less than a predetermined angle; and
a controller coupled to the sensor, the controller to prohibit operations by at least the first touch switch when the angle detected is less than the predetermined angle.

2. An information processing apparatus according to claim 1, wherein the controller interrupts power to be supplied to the first touch switch when the angle detected is less than the predetermined angle.

3. An information processing apparatus according to claim 1, wherein the controller disables data input from the first touch switch when the angle detected is less than the predetermined angle.

4. An information processing apparatus according to claim 1, further comprising:
a second touch switch positioned on the upper face of the main body, the second touch switch to input data according to a change in electrostatic capacity; and
a disabling unit to disable data input from the first touch switch and the second touch switch when the data is input from the first touch switch and the second touch switch.

5. An information processing apparatus according to claim 1, wherein the main body includes an end position proximate to a location where the display unit is coupled to the main body, and a keyboard provided at the upper face, where the first touch switch is arranged between the end position and the keyboard.

6. An information processing apparatus according to claim 5, further comprising:
a second touch switch configure to input data to components positioned within the main body according to a change in electrostatic capacity, and arranged at the upper face between the end position and the keyboard; and
a disabling unit to disable data input from the first touch switch and the second touch switch when the data is input concurrently from the first touch switch and the second touch switch.

7. An information processing apparatus according to claim 1, wherein the display unit includes a display panel with a light emitting unit, and an inverter which drives the light emitting unit.

8. An information processing apparatus according to claim 1, wherein the display unit includes a display panel, and an inverter positioned substantially opposite to the first touch switch when the display unit is at a closed position relative to the main body, the inverter driving a light emitting unit illuminating the display panel.

9. An information processing apparatus according to claim 1, wherein the main body includes an end position on which a supporting unit which supports the display unit is provided, and a keyboard provided at the upper face, and the first touch switch is arranged between the end position and the keyboard, and the display unit includes a display panel, a base end position supported on the supporting unit, and an inverter arranged between the display panel and the base end position, the inverter driving a light emitting unit illuminating the display panel.

10. An information processing apparatus according to claim 8, further comprising:
a second touch switch configure to input data into the main body according to a change in electrostatic capacity, and arranged at the upper face between the end position and the keyboard; and
a disabling unit to disable data input from the first touch switch and the second touch switch when the data is input from both the first touch switch and the second touch switch concurrently.

11. A method of controlling an information processing apparatus including a main body, a first touch switch arranged on an upper face of the main body for inputting data according to a change in electrostatic capacity, and a rotational display unit, comprising:
detecting whether or not an angle formed between a front face of the display unit and the upper face of the main body is less than a predetermined angle; and
prohibiting data input by the first touch switch when the detected angle is less than the predetermined angle.

12. A method of controlling an information processing apparatus, according to claim 11, wherein the information processing apparatus further comprises a second touch switch arranged at the upper face of the main body, the second touch switch to input data according to a change in electrostatic capacity, the method further comprising:
disabling data input from the first touch switch and the second touch switch when the data is input from both the first touch switch and the second touch switch.

13. A method according to claim 11, wherein the prohibiting of the data input includes disabling data input from the first touch switch.

14. A method according to claim 11, wherein the prohibiting of the data input includes interrupting power supplied to the first touch switch.

15. A computer comprising:
a main body including an upper face;
a first switch positioned on the upper face of the main body, the first switch to input data according to a change in electrostatic capacity;
a display unit coupled to the main body and including a front face; and
a controller to prohibit operations by at least the first switch upon detection that an angle formed between the front face of the display unit and the upper face of the main body is less than a predetermined angle.

16. A computer according to claim 15, wherein the controller interrupts power to be supplied to the first switch when the angle detected is less than the predetermined angle.

17. A computer according to claim 15, wherein the controller disables data input from the first switch when the angle detected is less than the predetermined angle.

18. A computer according to claim 15, further comprising:
a second switch positioned on the upper face of the main body, the second switch to input data according to a change in electrostatic capacity; and
means for disabling data input from the first switch and the second switch when the data is input concurrently from the first switch and the second switch.
